(19) United States
(12) Patent Application Publication
(10) Pub. No.: US 2010/0180082 A1
(43) Pub. Date: Jul. 15, 2010

(54) METHODS AND SYSTEMS FOR IMPLEMENTING URL MASKING

(75) Inventors: William B. Sebastian, Quincy, MA (US); Dan Newman, Littleton, MA (US)

Correspondence Address: TOWNSEND AND TOWNSEND AND CREW LLP;VIASAT, INC. (CLIENT #017018), TWO EMBARCADERO CENTER, 8TH FLOOR, SAN FRANCISCO, CA, 94111, US

(73) Assignee: ViaSat, Inc., Carlsbad, CA (US)

(21) Appl. No.: 12/571,281

(22) Filed: Sep. 30, 2009

Related U.S. Application Data
(60) Provisional application No. 61/143,933, filed on Jan. 12, 2009.

(51) Int. Cl. G06F 15/16; G06F 12/08

(52) U.S. Cl. 711/126; 709/235; 711/E12.017

(57) ABSTRACT

A method includes receiving a web content request including a URL string for locating the web content, and comparing the URL string to a list of URLs for which prefetched responses are available to see if the request can be fulfilled from these responses. The method further includes using a mask that excludes portions of the URL string that are not relevant to finding or selecting the web content when comparing the request to the list of prefetched URLs. If the request URL string matches the URL of a prefetched response other than the masked section, then the prefetched response can be supplied as a response to the incoming response. The method further includes parsing Java scripts in a web response to search for URLs that may be rendered on a web page and analyzing the scripts to identify bytes in the URL that would have random values.

### PRIORITY CLAIM

This application is a non-provisional application which claims priority to U.S. Provisional Application No. 61/143,933, entitled WEB OPTIMIZATION OVER SATELLITE LINKS, filed on Jan. 12, 2009, which is incorporated by reference in its entirety for any and all purposes.

### FIELD OF THE INVENTION

The present invention relates, in general, to network acceleration, and more particularly, to URL masking in prefetched and cached systems.

### BACKGROUND OF THE INVENTION

Presently, cold access (first visit on clear cache) to popular sites is a well-established metric for user experience on a public network, as it is the operation in which network performance is most clearly and frequently apparent to the end user. Consequently, improvements in this metric can play a significant role in driving consumer purchasing decisions, such as in selecting network access providers or deciding whether to use an acceleration service.

Performance for satellite access to commercial web sites can be significantly improved. Currently, an effective solution for many of the issues affecting satellite performance exist. For example, optimal transport protocols and compression are effective at reducing the number of bytes downloaded. However, another aspect of network acceleration involves the number of RTTs. At present, about 66% of the objects for cold access to public sites are prefetched, and many of the non-prefetched requests occur sequentially because URL references within Java scripts have to be resolved before subsequent HTML data can be parsed. Over a broadband satellite link, these accumulated RTTs are the largest contributor to download times.

Furthermore, delays in receiving content from upstream servers is another problem that broadband satellite links face. Even if all references could be prefetched from the initial request, the web page may be delayed while waiting for responses from the origin servers. Improvements in these two areas could potentially make a satellite link comparable to terrestrial broadband for accessing public web sites. The fastest fiber links must still wait for a series of requests to be satisfied from remote web hosts, so that the total download time is the accumulation of these web server response delays. Hence, improvements in the art are needed.

### BRIEF SUMMARY OF THE INVENTION

Embodiments of the present invention relate to a method for implementing URL masking. The method includes receiving a web content request including a URL string for locating the web content, and comparing the URL string to a list of URLs for which prefetched responses are available to see if the request can be fulfilled from these responses. The method further includes using a mask that excludes portions of the URL string that are not relevant to finding or selecting the web content when comparing the request to the list of prefetched URLs. If the request URL string matches the URL of a prefetched response other than the masked section, then the prefetched response can be supplied as a response to the incoming response. The method further includes parsing Java scripts in a web response to search for URLs that may be rendered on a web page and analyzing the scripts to identify bytes in the URL that would have random values. A mask is then generated that indicates which bytes are random and can be excluded from the comparison that determines whether a prefetched response can be used.

Another embodiment of the present invention includes a gateway configured to implement URL masking. The gateway includes an accelerator module configured to receive a web content response containing HTML or other file types containing Java script and parse the Java script to identify URLs that the client application such as a web browser can be expected to request in rendering the web page. The accelerator module analyzes the Java scripts to determine whether a function that produces random data is being used to generate part of the URL. If so, the random bytes in the URL are identified in a mask. The gateway further includes a gateway transceiver module in communication with the accelerator module. The gateway transceiver module is configured to receive the prefetched object and transmit the prefetched object to a terminal.

A further embodiment of the present invention provides a machine-readable medium for implementing URL masking. The machine-readable medium includes instructions for receiving a web content request including a URL string for locating the web content, and comparing the URL string to a list of URLs for which prefetched responses are available to see if the request can be fulfilled from these responses. The machine-readable medium further includes instructions for using a mask that excludes portions of the URL string that are not relevant to finding or selecting the web content when comparing the request to the list of prefetched URLs. If the request URL string matches the URL of a prefetched response other than the masked section, then the prefetched response can be supplied as a response to the incoming response. The machine-readable medium further includes instructions for parsing Java scripts in a web response to search for URLs that may be rendered on a web page and analyzing the scripts to identify bytes in the URL that would have random values. A mask is then generated that indicates which bytes are random and can be excluded from the comparison that determines whether a prefetched response can be used.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is a block diagram illustrating satellite communications, according to one embodiment of the present invention.

FIG. 2 is a block diagram illustrating a gateway, according to one embodiment of the present invention.

FIG. 3 is a block diagram illustrating a subscriber terminal, according to one embodiment of the present invention.

FIG. 4 is a generalized schematic diagram illustrating a computer system, in accordance with various embodiments of the invention.

FIG. 5 is a block diagram illustrating a networked system of computers, which can be used in accordance with various embodiments of the invention.

FIG. 6 is a block diagram illustrating a system for implementing prefetching, according to one embodiment of the present invention.

FIGS. 7A and 7B are block diagrams illustrating a network acceleration module, according to one embodiment of the present invention.

FIG. 8 is a flow diagram illustrating a method for implementing URL masking, according to one embodiment of the present invention.

FIG. 9 is a flow diagram illustrating a method for further implementing URL masking, according to one embodiment of the present invention.

FIG. 10 is a block diagram illustrating a system for implementing URL masking, according to one embodiment of the present invention.

### DETAILED DESCRIPTION OF THE INVENTION

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment, it being understood that various changes may be made in the function and arrangement of elements without departing from the spirit and scope as set forth in the appended claims. Some of the various exemplary embodiments may be summarized as follows.

According to some embodiments, a URL masking algorithm is provided to allow prefetchers and caches to work even when the URLs are constructed using scripts intended to block such behavior. For example, certain cache-busting techniques generate portions of the URL string, using Java scripts, to include unique values (e.g., random numbers, timestamps, etc.). As such, prefetchers may be fooled into thinking objects at the URL have not yet been prefetched, when in fact they have. Embodiments mask these cache-busting portions of the URL string to allow the prefetcher to recognize the request as a previously prefetched URL.

According to other embodiments, cache cycling is used to issue a fresh request to the content provider for website content each time the proxy server serves a request from cached data. For example, URL masking may allow a prefetcher to operate in the context of a cache-busting algorithm. Using prefetched content may reduce the apparent number of times the URL is requested, which may reduce advertising revenue and other metrics based on the number of requests. Cache cycling embodiments maintain the request metrics while allowing optimal prefetching in the face of cache-busting techniques.

According to other embodiments, a number of techniques are provided for optimizing prefetcher functionality. In one embodiment, an accumulator is provided for optimizing performance of an accelerator abort system. Chunked content (e.g., in HTTP chunked mode) is accumulated until enough data is available to make an abort decision. In another embodiment, socket mapping architectures are adjusted to allow prefetching of content copies for URLs requested multiple times on the same page. In yet another embodiment, persistent storage is adapted to cache prefetched, but unused data, and to provide access to the data to avoid subsequent redundant prefetching. In still another embodiment, DNS transparent proxy and prefetch are integrated with HTTP transparent proxy and prefetch, so as to piggyback DNS information with HTTP frames. In even another embodiment, prefetching is provided for the DNS associated with all hostnames called in java scripts to reduce the number of requests needed to the DNS server. And in another embodiment, delivery of objects is prioritized according to browser rendering characteristics. For example, data is serialized back to a subscriber's browser so as to prioritize objects needing further parsing or having valuable information with respect to rendering.

It will be appreciated that these and other embodiments will be described in more detail below and with respect to the appended figures. In the appended figures, similar components and/or features may have the same reference label. Further, various components of the same type may be distinguished by following the reference label by a dash and a second label that distinguishes among the similar components. If only the first reference label is used in the specification, the description is applicable to any one the similar components having the same first reference label irrespective of the second reference label.

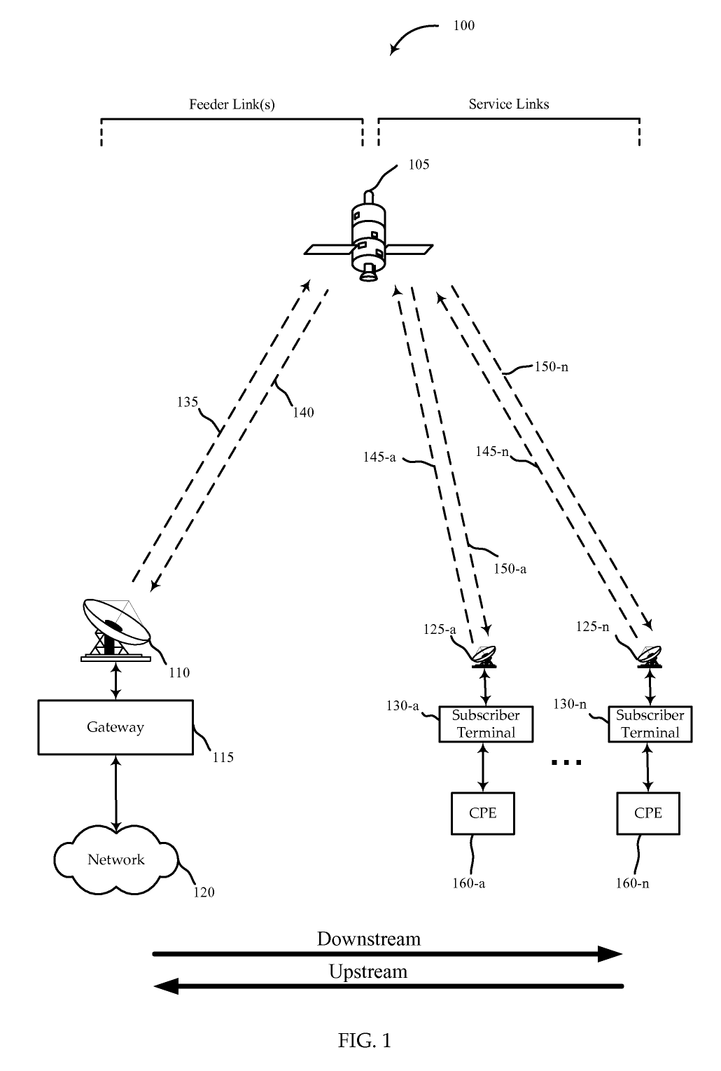

Referring first to FIG. 1, a block diagram is shown of one embodiment of a satellite communications system 100. The satellite communications system 100 includes a network 120, such as the Internet, interfaced with a gateway 115 that is configured to communicate with one or more subscriber terminals 130, via a satellite 105. A gateway 115 is sometimes referred to as a hub or ground station. Subscriber terminals 130 are sometimes called modems, satellite modems, or user terminals. As noted above, although the communications system 100 is illustrated as a geostationary satellite 105 based communication system, it should be noted that various embodiments described herein are not limited to use in geostationary satellite based systems; for example, some embodiments could be low earth orbit (“LEO”) satellite based systems or aerial payloads not in orbit and held aloft by planes, blimps, weather balloons, etc. Other embodiments could have a number of satellites instead of just one.

The network 120 may be any type of network and can include, for example, the Internet, an Internet protocol (“IP”) network, an intranet, a wide-area network (“WAN”), a local-area network (“LAN”), a virtual private network (“VPN”), the Public Switched Telephone Network (“PSTN”), and/or any other type of network supporting data communication between devices described herein, in different embodiments. A network 120 may include both wired and wireless connections, including optical links. As illustrated in a number of embodiments, the network 120 may connect the gateway 115 with other gateways (not shown), which are also in communication with the satellite 105.

The gateway 115 provides an interface between the network 120 and the satellite 105. The gateway 115 may be configured to receive data and information directed to one or more subscriber terminals 130, and can format the data and information for delivery to the respective destination device via the satellite 105. Similarly, the gateway 115 may be configured to receive signals from the satellite 105 (e.g., from one or more subscriber terminals 130) directed to a destination in the network 120, and can process the received signals for transmission along the network 120.

A device (not shown) connected to the network 120 may communicate with one or more subscriber terminals 130. Data and information, for example IP datagrams, may be sent from a device in the network 120 to the gateway 115. It will be appreciated that the network 120 may be in further communication with a number of different types of providers, including content providers, application providers, service providers, etc. Further, in various embodiments, the providers may communicate content with the satellite communication system 100 through the network 120, or through other components of the system (e.g., directly through the gateway 115).

The gateway 115 may format frames in accordance with a physical layer definition for transmission to the satellite 105. A variety of physical layer transmission modulation and coding techniques may be used with certain embodiments, including those defined with the DVB-S2 standard. The link 135 from the gateway 115 to the satellite 105 may be referred to hereinafter as the downstream uplink 135. The gateway 115 uses the antenna 110 to transmit the content to the satellite 105. In one embodiment, the antenna 110 comprises a parabolic reflector with high directivity in the direction of the satellite and low directivity in other directions.

In one embodiment, a geostationary satellite 105 is configured to receive the signals from the location of antenna 110 and within the frequency band and specific polarization transmitted. The satellite 105 may, for example, use a reflector antenna, lens antenna, array antenna, active antenna, or other mechanism for reception of such signals. The satellite 105 may process the signals received from the gateway 115 and forward the signal from the gateway 115 containing the MAC frame to one or more subscriber terminals 130. In one embodiment, the satellite 105 operates in a multi-beam mode, transmitting a number of narrow beams each directed at a different region of the earth.

With such a multibeam satellite 105, there may be any number of different signal switching configurations on the satellite 105, allowing signals from a single gateway 115 to be switched between different spot beams. In one embodiment, the satellite 105 may be configured as a “bent pipe” satellite, wherein the satellite may frequency convert the received carrier signals before retransmitting these signals to their destination, but otherwise perform little or no other processing on the contents of the signals. There could be a single carrier signal for each service spot beam or multiple carriers in different embodiments. Similarly, single or multiple carrier signals could be used for the feeder spot beams. A variety of physical layer transmission modulation and coding techniques may be used by the satellite 105 in accordance with certain embodiments, including those defined with the DVB-S2 standard. For other embodiments, a number of configurations are possible (e.g., using LEO satellites, or using a mesh network instead of a star network).

The service signals transmitted from the satellite 105 may be received by one or more subscriber terminals 130, via the respective subscriber antenna 125. In one embodiment, the subscriber antenna 125 and terminal 130 together comprise a very small aperture terminal (“VSAT”), with the antenna 125 measuring approximately 0.6 meters in diameter and having approximately 2 watts of power. In other embodiments, a variety of other types of subscriber antennae 125 may be used at the subscriber terminal 130 to receive the signal from the satellite 105. The link 150 from the satellite 105 to the subscriber terminals 130 may be referred to hereinafter as the downstream downlink 150. Each of the subscriber terminals 130 may include a hub or router (not pictured) that is coupled to multiple subscriber terminals 130.

In some embodiments, some or all of the subscriber terminals 130 are connected to consumer premises equipment (“CPE”) 160. CPE may include, for example, computers, local area networks, Internet appliances, wireless networks, etc. A subscriber terminal 130, for example 130-a, may transmit data and information to a network 120 destination via the satellite 105. The subscriber terminal 130 transmits the signals via the upstream uplink 145-a to the satellite 105 using the subscriber antenna 125-a. The link from the satellite 105 to the gateway 115 may be referred to hereinafter as the upstream downlink 140.

In various embodiments, one or more of the satellite links 135, 140, 145, 150 are capable of communicating using one or more communication schemes. In various embodiments, the communication schemes may be the same or different for different links. The communication schemes may include different types of coding and modulation combinations. For example, various satellite links may communicate using physical layer transmission modulation and coding techniques using adaptive coding and modulation schemes, etc. The communication schemes may also use one or more different types of multiplexing schemes, including Multi-Frequency Time-Division Multiple Access (“MF-TDMA”), Time Division Multiple Access (“TDMA”), Frequency Division Multiple Access (“FDMA”), Orthogonal Frequency Division Multiple Access (“OFDMA”), Code Division Multiple Access (“CDMA”), or any number of other schemes.

In a given satellite spot beam, all customers serviced by the spot beam may be capable of receiving all the content traversing the spot beam by virtue of the fact that the satellite communications system 100 employs wireless communications via various antennae (e.g., 110 and 125). However, some of the content may not be intended for receipt by certain customers. As such, the satellite communications system 100 may use various techniques to “direct” content to a subscriber or group of subscribers. For example, the content may be tagged (e.g., using packet header information according to a transmission protocol) with a certain destination identifier (e.g., an IP address) or use different modcode points. Each subscriber terminal 130 may then be adapted to handle the received data according to the tags. For example, content destined for a particular subscriber terminal 130 may be passed on to its respective CPE 160, while content not destined for the subscriber terminal 130 may be ignored. In some cases, the subscriber terminal 130 caches information not destined for the associated CPE 160 for use if the information is later found to be useful in avoiding traffic over the satellite link.

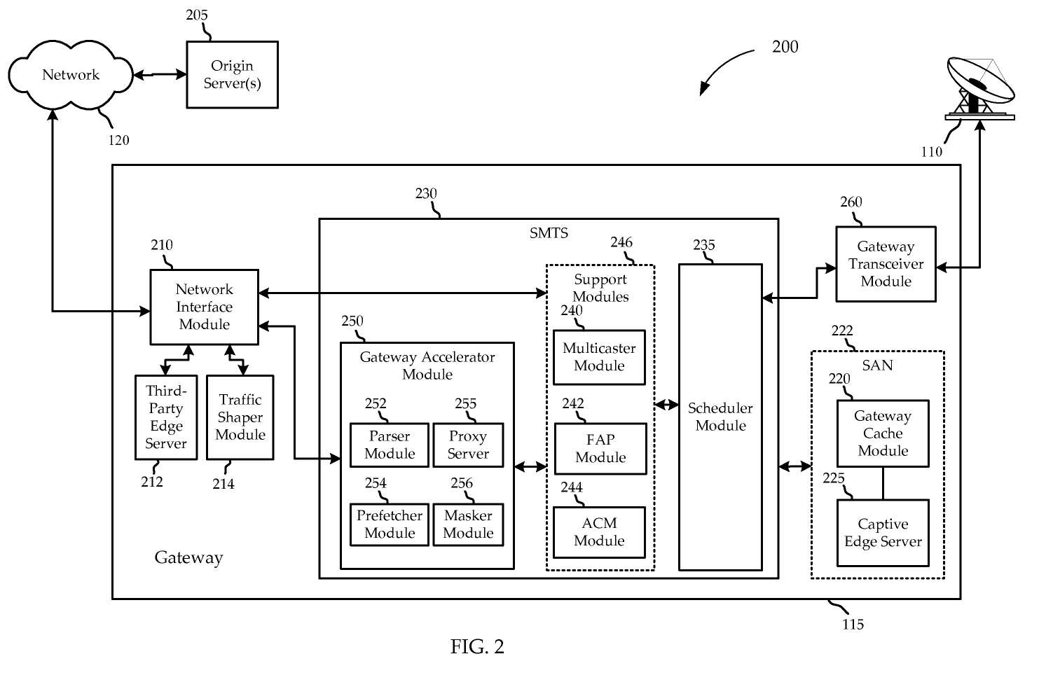

FIG. 2 shows a simplified block diagram 200 illustrating an embodiment of a gateway 115 coupled between the network 120 and an antenna 110, according to various embodiments. The gateway 115 has a number of components, including a network interface module 210, a satellite modem termination system (“SMTS”) 230, and a gateway transceiver module 260. Components of the gateway 115 may be implemented, in whole or in part, in hardware. Thus, they may comprise one, or more, Application Specific Integrated Circuits (“ASICs”) adapted to perform a subset of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (“FPGAs”) and other Semi-Custom ICs), which may be programmed. Each may also be implemented, in whole or in part, with instructions embodied in a computer-readable medium, formatted to be executed by one or more general or application specific controllers.

Embodiments of the gateway 115 receive data from the network 120 (e.g., the network 120 of FIG. 1), including data originating from one or more origin servers 205 (e.g., content servers) and destined for one or more subscribers in a spot beam. The data is received at the network interface module 210, which includes one or more components for interfacing with the network 120. For example, the network interface module 210 includes a network switch and a router.

In some embodiments, the network interface module 210 interfaces with other modules, including a third-party edge server 212 and/or a traffic shaper module 214. The third-party edge server 212 may be adapted to mirror content (e.g., implementing transparent mirroring, like would be performed in a point of presence (“POP”) of a content delivery network (“CDN”)) to the gateway 115. For example, the third-party edge server 212 may facilitate contractual relationships between content providers and service providers to move content closer to subscribers in the satellite communication network 100. The traffic shaper module 214 controls traffic from the network 120 through the gateway 115, for example, to help optimize performance of the satellite communication system 100 (e.g., by reducing latency, increasing effective bandwidth, etc.). In one embodiment, the traffic shaper module 214 delays packets in a traffic stream to conform to a predetermined traffic profile.

Traffic is passed from the network interface module 210 to the SMTS 230 to be handled by one or more of its component modules. In some embodiments, the SMTS 230 includes a gateway accelerator module 250, a scheduler module 235, and support modules 246. In some embodiments, all traffic from the network interface module 210 is passed to the gateway accelerator module 250 for handling, as described more fully below. In other embodiments, some or all of the traffic from the gateway accelerator module 250 is passed to the support modules 246. For example, in one embodiment, real-time types of data (e.g., User Datagram Protocol (“UDP”) data traffic, like Internet-protocol television (“IPTV”) programming) bypass the gateway accelerator module 250, while non-real-time types of data (e.g., Transmission Control Protocol (“TCP”) data traffic, like web video) are routed through the gateway accelerator module 250 for processing.

Embodiments of the gateway accelerator module 250 provide various types of application, WAN/LAN, and/or other acceleration functionality. In one embodiment, the gateway accelerator module 250 implements functionality of AcceleNet applications from Intelligent Compression Technologies, Inc. (“ICT”), a division of ViaSat, Inc. This functionality may be used to exploit information from application layers of the protocol stack (e.g., layers 4-7 of the IP stack) through use of software or firmware operating in the subscriber terminal 130 and/or CPE 160.

Embodiments of the gateway accelerator module 250 also include a gateway parser module 252, a gateway prefetcher module 254, and/or a gateway masker module 246. The gateway parser module 252 provides various script parsing functions for supporting functionality of the gateway accelerator module 250. For example, the gateway parser module 252 may be configured to implement advanced parsing of Java scripts to interpret web requests for use in prefetching.

Prefetching functionality may be implemented through the gateway prefetcher module 254 in the gateway accelerator module 250. Embodiments of the gateway prefetcher module 254 handle one or more of various prefetching functions, including receiving and interpreting instructions from other components of the gateway accelerator module 250 as to what objects to prefetch, receiving and interpreting instructions from components of the subscriber terminal 130, generating and/or sending instructions to one or more content servers to retrieve prefetch objects, keeping track of prefetched and/or cached content, directing objects to be cached (e.g., in the gateway cache module 220), etc.

In some embodiments, functionality of the gateway prefetcher module 254 and/or the gateway parser module 252 is optimized by other components of the gateway accelerator module 250. For example, requested URLs embedded in Java script may be parsed by the gateway parser module 252, and related objects may be prefetched by the gateway prefetcher module 254. However, certain cache-busting techniques may limit the effectiveness of the gateway prefetcher module 254 (e.g., by fooling the gateway parser module 252). Embodiments of the gateway masker module 246 are configured to implement URL masking to counter these cache-busting techniques, as discussed more fully below.

In some embodiments, the gateway accelerator module 250 is adapted to provide high payload compression. For example, the gateway accelerator module 250 may compress payload such that over 70% of upload traffic when browsing the web in some cases is being used by transport management, and other items other than the compressed payload data. In other embodiments, functionality of the gateway accelerator module 250 is closely integrated with the satellite link through components of the SMTS 230 to reduce upload bandwidth requirements and/or to more efficiently schedule to satellite link (e.g., by communicating with the scheduler module 235). For example, the link layer may be used to determine whether packets are successfully delivered, and those packets can be tied more closely with the content they supported through application layer information. In certain embodiments, these and/or other functions of the gateway accelerator module 250 are provided by a proxy server 255 resident on (e.g., or in communication with) the gateway accelerator module 250.

In some embodiments, the proxy server 255 is implemented with multiple servers. Each of the multiple servers may be configured to handle a portion of the traffic passing through the gateway accelerator module 250. It is worth noting that functionality of various embodiments described herein use data which, at times, may be processed across multiple servers. As such, one or more server management modules may be provided for processing (e.g., tracking, routing, partitioning, etc.) data across the multiple servers. For example, when one server within the proxy server 255 receives a request from a subscriber terminal 130 on the spot beam, the server management module may process that request in the context of other similar requests received at other severs in the proxy server 255.

Data processed by the gateway accelerator module 250 may pass through the support modules 246 to the scheduler 235. Embodiments of the support modules 246 include one or more types of modules for supporting the functionality of the SMTS 230, for example, including a multicaster module 240, a fair access policy (“FAP”) module, and an adaptive coding and modulation (“ACM”) module. In certain embodiments, some or all of the support modules 246 include off-the-shelf types of components.

Embodiments of the multicaster module 240 provide various functions relating to multicasting of data over the links of the satellite communication system 100. Certain embodiments of the multicaster module 240 use data generated by other components of the SMTS 230 (e.g., the gateway accelerator module 250) to prepare traffic for multicasting. For example, the multicaster module 240 may prepare datagrams as a multicast stream. Other embodiments of the multicaster module 240 perform more complex multicasting-related functionality. For example, the multicaster module 240 may contribute to determinations of whether data is unicast or multicast to one or more subscribers (e.g., using information generated by the gateway accelerator module 250), what modcodes to use, whether data should or should not be sent as a function of data cached as destination subscriber terminals 130, how to handle certain types of encryption, etc.

Embodiments of the FAP module 242 implement various FAP-related functions. In one embodiment, the FAP module 242 collects data from multiple components to determine how much network usage to attribute to a particular subscriber. For example, the FAP module 242 may determine how to count upload or download traffic against a subscriber's FAP. In another embodiment, the FAP module 242 dynamically adjusts FAPs according to various network link and/or usage conditions. For example, the FAP module 242 may adjust FAPs to encourage network usage during lower traffic times. In yet another embodiment, the FAP module 242 affects the operation of other components of the SMTS 230 as a function of certain FAP conditions. For example, the FAP module 242 may direct the multicaster module 240 to multicast certain types of data or to prevent certain subscribers from joining certain multicast streams as a function of FAP considerations.

Embodiments of the ACM module 244 implement various ACM functions. For example, the ACM module 244 may track link conditions for certain spot beams, subscribers, etc., for use in dynamically adjusting modulation and/or coding schemes. In some embodiments, the ACM module 244 may help determine which subscribers should be included in which customer groupings or multicast streams as a function of optimizing resources through modcode settings. In certain embodiments, the ACM module 244 implements ACM-aware encoding of data adapted for progressive encoding. For example, MPEG-4 video data may be adapted for progressive encoding in layers (e.g., a base layer and enhancement layers). The ACM module 244 may be configured to set an appropriate modcode separately for each layer to optimize video delivery.

When traffic has been processed by the gateway accelerator module 250 and/or the support modules 246, the traffic is passed to the scheduler module 235. Embodiments of the scheduler module 235 are configured to provide various functions relating to scheduling the links of the satellite communication system 100 handled by the gateway 115. For example, the scheduler module 235 may manage link bandwidth by scheduling license grants within a spot beam.

In some embodiments, functionality of the SMTS 230 involves communication and interaction with a storage area network 222 (“SAN”). Embodiments of the SAN 222 include a gateway cache module 220, which may include any useful type of memory store for various types of functionality of the gateway 115. For example, the gateway cache module 220 may include volatile or non-volatile storage, servers, files, queues, etc. In certain embodiments, the SAN 222 further includes a captive edge server 225, which may be in communication with the gateway cache module 220. In some embodiments, the captive edge server 225 provides functionality similar to that of the third-party edge server 212, including content mirroring. For example, the captive edge server 225 may facilitate different contractual relationships from those of the third-party edge server 212 (e.g., between the gateway 115 provider and various content providers).

It will be appreciated that the SMTS 230 provides many different types of functionality. For example, embodiments of the SMTS 230 oversee a variety of decoding, interleaving, decryption, and unscrambling techniques. The SMTS 230 may also manage functions applicable to the communication of content downstream through the satellite 105 to one or more subscriber terminals 130. As described more fully below with reference to various embodiments, the SMTS may handle different types of traffic in different ways (e.g., for different use cases of the satellite communication network 100). For example, some use cases involve contractual relationships and/or obligations with third-party content providers to interface with their edge servers (e.g., through the third-party edge server 212), while other use cases involve locally “re-hosting” certain content (e.g., through the captive edge server 225). Further, some use cases handle real-time types of data (e.g., UDP data) differently from non-real-time types of data (e.g., TCP data). Many other types of use cases are possible.

In certain embodiments, some or all of these downstream communication functions are handled by the gateway transceiver module 260. Embodiments of the gateway transceiver module 260 encode and/or modulate data, using one or more error correction techniques, adaptive encoding techniques, baseband encapsulation, frame creation, etc. (e.g., using various modcodes, lookup tables, etc.). Other functions may also be performed by these components (e.g., by the SMTS 230), including upconverting, amplifying, filtering, tuning, tracking, etc. The gateway transceiver module 260 communicates data to one or more antennae 110 for transmission via the satellite 105 to the subscriber terminals 130.

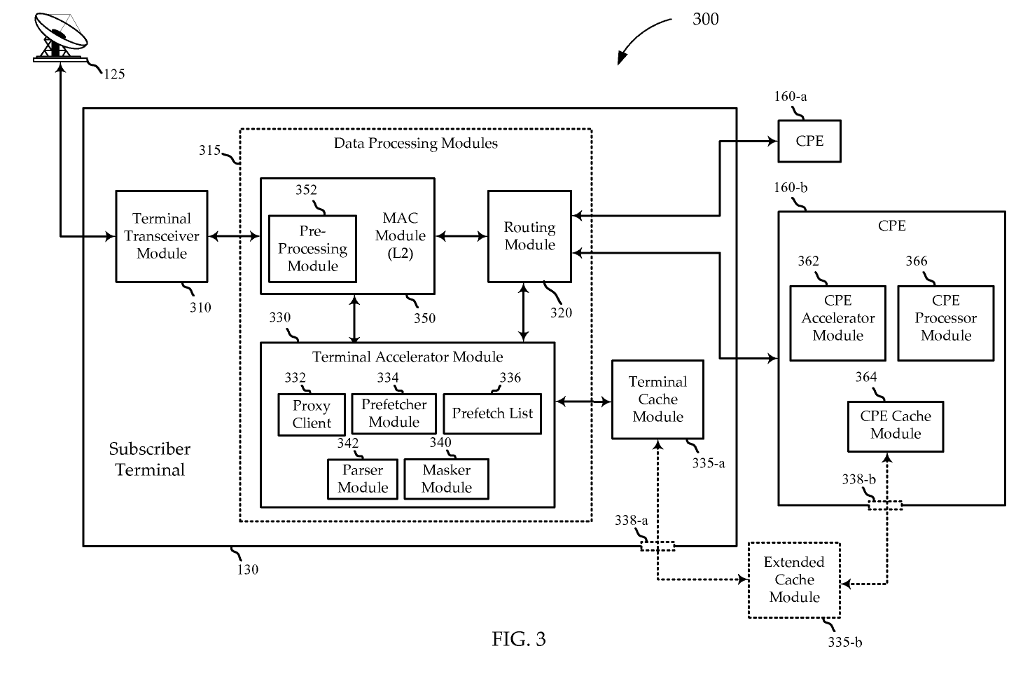

FIG. 3 shows a simplified block diagram 300 illustrating an embodiment of a subscriber terminal 130 coupled between the respective subscriber antenna 125 and the CPE 160, according to various embodiments. The subscriber terminal 130 includes a terminal transceiver module 310, data processing modules 315, and a terminal cache module 335-a. Embodiments of the data processing modules 315 include a MAC module 350, a terminal accelerator module 330, and a routing module 320.

The components may be implemented, in whole or in part, in hardware. Thus, they may comprise one, or more, Application Specific Integrated Circuits (“ASICs”) adapted to perform a subset of the applicable functions in hardware. Alternatively, the functions may be performed by one or more other processing modules (or cores), on one or more integrated circuits. In other embodiments, other types of integrated circuits may be used (e.g., Structured/Platform ASICs, Field Programmable Gate Arrays (“FPGAs”) and other Semi-Custom ICs), which may be programmed. Each may also be implemented, in whole or in part, with instructions embodied in a computer-readable medium, formatted to be executed by one or more general or application specific processors.

A signal from the subscriber antenna 125 is received by the subscriber terminal 130 at the terminal transceiver module 310. Embodiments of the terminal transceiver module 310 may amplify the signal, acquire the carrier, and/or downconvert the signal. In some embodiments, this functionality is performed by other components (either inside or outside the subscriber terminal 130).

In some embodiments, data from the terminal transceiver module 310 (e.g., the downconverted signal) is communicated to the data processing modules 315 for processing. For example, data is communicated to the MAC module 350. Embodiments of the MAC module 350 prepare data for communication to other components of, or in communication with, the subscriber terminal 130, including the terminal accelerator module 330, the routing module 320, and/or the CPE 160. For example, the MAC module 350 may modulate, encode, filter, decrypt, and/or otherwise process the data to be compatible with the CPE 160.

In some embodiments, the MAC module 350 includes a pre-processing module 352. The pre-processing module 352 implements certain functionality for optimizing the other components of the data processing modules 315. In some embodiments, the pre-processing module 352 processes the signal received from the terminal transceiver module by interpreting (e.g., and decoding) modulation and/or coding schemes, interpreting multiplexed data streams, filtering the digitized signal, parsing the digitized signal into various types of information (e.g., by extracting the physical layer header), etc. In other embodiments, the pre-processing module 352 pre-filters traffic to determine which data to route directly to the routing module 320, and which data to route through the terminal accelerator module 330 for further processing.

Embodiments of the terminal accelerator module 330 provide substantially the same functionality as the gateway accelerator module 250, including various types of applications, WAN/LAN, and/or other acceleration functionality. In one embodiment, the terminal accelerator module 330 implements functionality of AcceleNet™ applications, like interpreting data communicated by the gateway 115 using high payload compression, handling various prefetching functions, parsing scripts to interpret requests, etc. In certain embodiments, these and/or other functions of the terminal accelerator module 330 are provided by a proxy client 332 resident on (e.g., or in communication with) the terminal accelerator module 330. Data from the MAC module 350 and/or the terminal accelerator module 330 may then be routed to one or more CPEs 160 by the routing module 320.

In some embodiments, the terminal accelerator module 330 includes a terminal prefetcher module 334, a terminal parser module 342, and/or a terminal masker module 340. In various embodiments, the terminal parser module 342, the terminal prefetcher module 334, and the terminal masker module 340 provide the same or similar functionality as the gateway parser module 252, the gateway prefetcher module 254, and the gateway masker module 246, respectively. For example, similar modules in the terminal accelerator module 330 and the gateway accelerator module 250 may work together to implement their respective functions. In other embodiments, the components of the subscriber terminal 130 and the gateway 115 provide different functionality. For example, functionality of the gateway parser module 252 may be asymmetric, such that it would not be desirable or possible to provide the same functionality in the terminal parser module 342. In some embodiments, the terminal accelerator module 330 further includes a prefetch list 336.

In some embodiments, output from the data processing module 320 and/or the terminal accelerator module 330 is stored in the terminal cache module 335-a. Further, the data processing module 320 and/or the terminal accelerator module 330 may be configured to determine what data should be stored in the terminal cache module 335-a and which data should not (e.g., which data should be passed to the CPE 160). It will be appreciated that the terminal cache module 335-a may include any useful type of memory store for various types of functionality of the subscriber terminal 130. For example, the terminal cache module 335-a may include volatile or non-volatile storage, servers, files, queues, etc.

In certain embodiments, storage functionality and/or capacity is shared between an integrated (e.g., on-board) terminal cache module 335-a and an extended (e.g., off-board) cache module 335-b. For example, the extended cache module 335-b may be implemented in various ways, including as an attached peripheral device (e.g., a thumb drive, USB hard drive, etc.), a wireless peripheral device (e.g., a wireless hard drive), a networked peripheral device (e.g., a networked server), etc. In some embodiments, the subscriber terminal 130 interfaces with the extended cache module 335-b through one or more ports 338. In one embodiment, functionality of the terminal cache module 335-a is implemented as storage integrated into or in communication with the CPE 160 of FIG. 1.

Some embodiments of the CPE 160 are standard CPE 160 devices or systems with no specifically tailored hardware or software (e.g., shown as CPE 160-a). Other embodiments of the CPE 160, however, include hardware and/or software modules adapted to optimize or enhance integration of the CPE 160 with the subscriber terminal 130 (e.g., shown as alternate CPE 160-b). For example, the alternate CPE 160-b is shown to include a CPE accelerator module 362, a CPE processor module 366, and a CPE cache module 364. Embodiments of the CPE accelerator module 362 are configured to implement the same, similar, or complimentary functionality as the terminal accelerator module 330. For example, the CPE accelerator module 362 may be a software client version of the terminal accelerator module 330. In some embodiments, some or all of the functionality of the data processing modules 315 is implemented by the CPE accelerator module 362 and/or the CPE processor module. In these embodiments, it may be possible to reduce the complexity of the subscriber terminal by shifting functionality to the alternate CPE 160-b. Embodiments of the CPE cache module 364 may include any type of data caching components in or in communication with the alternate CPE 160-b (e.g., a computer hard drive, a digital video recorder (“DVR”), etc.). In some embodiments, the CPE cache module 364 is in communication with the extended cache module 335-b, for example, via one or more ports 338-b.

In certain embodiments, the subscriber terminal 130 is configured to transmit data back to the gateway 115. Embodiments of the data processing modules 315 and the terminal transceiver module 310 are configured to provide functionality for communicating information back through the satellite communication system 100 (e.g., for directing provision of services). For example, information about what is stored in the terminal cache module 335-a or the CPE cache module 364 may be sent back to the gateway 115 for limiting repetitious file transfers, as described more fully below.

It will be appreciated that the satellite communications system 100 may be used to provide different types of communication services to subscribers. For example, the satellite communications system 100 may provide content from the network 120 to a subscriber's CPE 160, including Internet content, broadcast television and radio content, on-demand content, voice-over-Internet-protocol (“VoIP”) content, and/or any other type of desired content. It will be further appreciated that this content may be communicated to subscribers in different ways, including through unicast, multicast, broadcast, and/or other communications.

Embodiments include methods, systems, and devices that implement various techniques for optimizing web access over satellite communication links. It will be appreciated that other components and systems may be used to provide functionality of the various embodiments described herein. As such, descriptions of various embodiments in the context of components and functionality of FIGS. 1-3 are intended only for clarity, and should not be construed as limiting the scope of the invention.

For example, embodiments of the invention may be used to address certain cold access metrics. Cold access (e.g., a first visit to a website with a clear cache) to popular websites is a well-established metric for user experience on a public network, as it is the operation in which network performance is most clearly and frequently apparent to the end user. Consequently, improvements in this cold access metric can play a role in driving consumer purchasing decisions, such as in selecting network access providers or deciding whether to use an acceleration service. There are a number of factors that may contribute to the cold access metric.

Some factors that may contribute to the cold access metric relate to the number of round trip times (“RTTs”) needed to communicate content between elements of the satellite systems (e.g., between the gateway 115 and the subscriber terminal 130 of the satellite communication system 100 of FIG. 1). Because of the large distance that must be traveled to and from the satellite 105, some data latency is inherent in any satellite communication system 100. This latency may be increased with each RTT needed to fulfill a request for data. As such, reducing the number of RTTs needed to communicate information over the satellite communication system 100 may significantly reduce the data transfer times (e.g., download times) over the communication links.

Other factors that may contribute to the cold access metric relate to delays caused by waiting for content from upstream servers. For example, the gateway prefetcher module 254 and/or the terminal prefetcher module 334 may be capable of determining from a website request how to prefetch much of the content for the website (e.g., through intelligent script parsing). However, receipt of the prefetched content may be delayed while the gateway 115 (e.g., acting as a proxy server) waits for responses from origin servers serving the website content. These delays may substantially offset reductions in delay provided by the prefetching functionality of the gateway prefetcher module 254 and/or the terminal prefetcher module 334.

Embodiments of the invention implement various types of functionality to address these and other factors to optimize web access performance. Some embodiments use acceleration functionality like advanced prefetching and compression (e.g., through the gateway accelerator module 250 and/or the terminal accelerator module 330) to reduce the number of RTTs. Other embodiments use uniform resource locator (“URL”) anti-aliasing and/or cycle caching functionality to enhance performance of the satellite communication system 100 without substantially interfering with the commercial objectives of the content providers. Still other embodiments provide improved parsing functionality to optimize prefetching results.

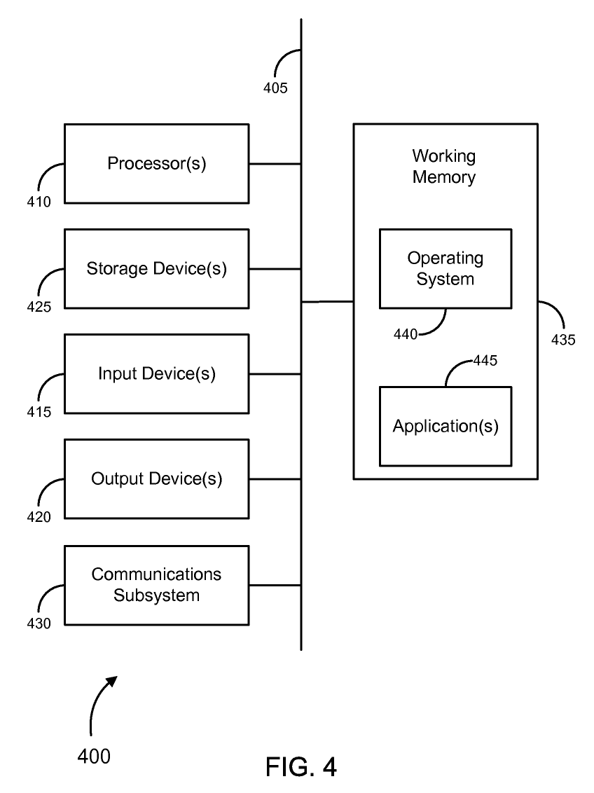

FIG. 4 provides a schematic illustration of one embodiment of a computer system 400 that can perform the methods of the invention, as described herein, and/or can function as, for example, gateway 115, subscriber terminal 130, etc. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements can include one or more processors 410, including without limitation one or more general-purpose processors and/or one or more special-purpose processors (such as digital signal processing chips, graphics acceleration chips, and/or the like); one or more input devices 415, which can include without limitation a mouse, a keyboard and/or the like; and one or more output devices 420, which can include without limitation a display device, a printer and/or the like.

The computer system 400 may further include (and/or be in communication with) one or more storage devices 425, which can comprise, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computer system 400 might also include a communications subsystem 430, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 430 may permit data to be exchanged with a network (such as the network described below, to name one example), and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440 and/or other code, such as one or more application programs 445, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 425 described above. In some cases, the storage medium might be incorporated within a computer system, such as the system 400. In other embodiments, the storage medium might be separate from a computer system (e.g., a removable medium, such as a compact disc, etc.), and/or provided in an installation package, such that the storage medium can be used to program a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 400) to perform methods of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another machine-readable medium, such as one or more of the storage device(s) 425. Merely by way of example, execution of the sequences of instructions contained in the working memory 435 might cause the processor(s) 410 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 400, various machine-readable media might be involved in providing instructions/code to processor(s) 410 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 425. Volatile media includes, without limitation, dynamic memory, such as the working memory 435. Transmission media includes coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infra-red data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc., carried by the signals) to the working memory 435, from which the processor(s) 405 retrieves and executes the instructions. The instructions received by the working memory 435 may optionally be stored on a storage device 425 either before or after execution by the processor(s) 410.

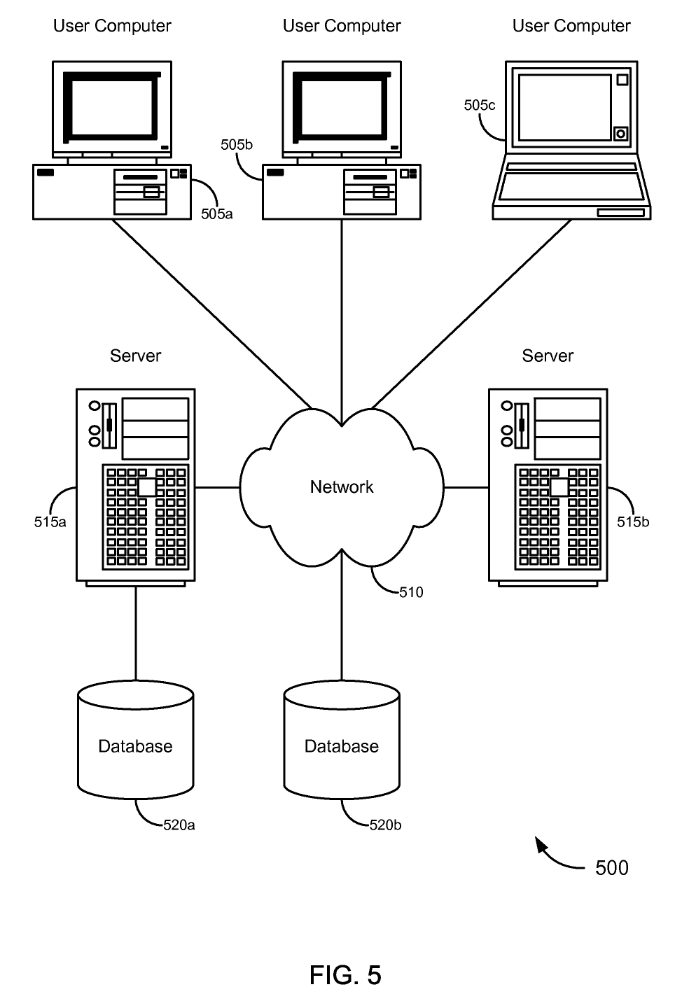

A set of embodiments comprises systems for managing identity information and generating an identity confidence scoring system. Merely by way of example, FIG. 5 illustrates a schematic diagram of a system 500 that can be used in accordance with one set of embodiments. The system 500 can include one or more user computers 505. The user computers 505 can be general purpose personal computers (including, merely by way of example, personal computers and/or laptop computers running any appropriate flavor of Microsoft Corp.'s Windows™ (e.g., Vista™) and/or Apple Corp.'s Macintosh™ operating systems) and/or workstation computers running any of a variety of commercially available UNIX™ or UNIX-like operating systems. These user computers 505 can also have any of a variety of applications, including one or more applications configured to perform methods of the invention, as well as one or more office applications, database client and/or server applications, and web browser applications. Alternatively, the user computers 505 can be any other electronic device, such as a thin-client computer, Internet-enabled mobile telephone, and/or personal digital assistant (PDA), capable of communicating via a network (e.g., the network 510 described below) and/or displaying and navigating web pages or other types of electronic documents. Although the exemplary system 500 is shown with three user computers 505, any number of user computers can be supported.

Certain embodiments of the invention operate in a networked environment, which can include a network 510. The network 510 can be any type of network familiar to those skilled in the art that can support data communications using any of a variety of commercially available protocols, including without limitation TCP/IP, SNA, IPX, AppleTalk, and the like. Merely by way of example, the network 510 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 515. Each of the server computers 515 may be configured with an operating system, including without limitation any of those discussed above, as well as any commercially (or freely) available server operating systems. Each of the servers 515 may also be running one or more applications, which can be configured to provide services to one or more clients 505 and/or other servers 515.

Merely by way of example, one of the servers 515 may be a web server, which can be used, merely by way of example, to process requests for web pages or other electronic documents from user computers 505. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 505 to perform methods of the invention.

The server computers 515, in some embodiments, might include one or more application servers, which can include one or more applications accessible by a client running on one or more of the client computers 505 and/or other servers 515. Merely by way of example, the server(s) 515 can be one or more general purpose computers capable of executing programs or scripts in response to the user computers 505 and/or other servers 515, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 505 and/or another server 515. In some embodiments, an application server can create web pages dynamically for displaying the information in accordance with embodiments of the invention. Data provided by an application server may be formatted as web pages (comprising HTML, Javascript, etc., for example) and/or may be forwarded to a user computer 505 via a web server (as described above, for example). Similarly, a web server might receive web page requests and/or input data from a user computer 505 and/or forward the web page requests and/or input data to an application server. In some cases, a web server may be integrated with an application server.

In accordance with further embodiments, one or more servers 515 can function as a file server and/or can include one or more of the files (e.g., application code, data files, etc.) necessary to implement methods of the invention incorporated by an application running on a user computer 505 and/or another server 515. Alternatively, as those skilled in the art will appreciate, a file server can include all necessary files, allowing such an application to be invoked remotely by a user computer 505 and/or server 515. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 515a (and/or a user computer 505). Alternatively, a database 520b can be remote from any or all of the computers 505, 515, so long as the database can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505, 515 can be stored locally on the respective computer and/or remotely, as appropriate.) In one set of embodiments, the database 520 can be a relational database, such as an Oracle™ database, that is adapted to store, update, and retrieve data in response to SQL-formatted commands. The database might be controlled and/or maintained by a database server, as described above, for example.

Public web sites may deploy Java scripts that make each request for an object appear with a unique URL. For example, this technique allows cycling of ad content and also prevents caches from interfering with the accounting of site accesses. These so-called “cache-busting” techniques may limit prefetching functionality (e.g., functionality of the gateway prefetcher module 254 and/or the terminal prefetcher module 334), as the URL prefetched on the proxy server will often not match the one from the browser. For example, to protect their commercial interests with respect to delivery and accounting of advertising content, commercial websites employ a number of cache-busting techniques.

One illustrative cache-busting technique uses functions, such as random number generators and millisecond timestamps, to produce unique values each time they are executed. These unique values may then be used as part of a URL to generate unique URLs with each subsequent request for the same website. For example, an illustrative Java script for generating a URL is as follows:

```
if (cacheBust)
{ var cacheStamp = new Date( );
  var cacheBuster = cacheStamp.getTime( );
  xmlURL =
  http://sports.myNetwork.com/ login/loggedIn?rand=‘+cacheBuster;
}
```

The time string appended to the URL is an integer with millisecond precision, so that no two calls to this routine may ever result in the same URL string. As such, with each subsequent call to the URL, a parser (e.g., the terminal parser module 342) may parse the request as looking for a new (i.e., not cached) set of content, causing the terminal prefetcher module 334 to direct multiple sequential accesses from content servers (e.g., via the gateway prefetcher module 254). It will be appreciated that each subsequent request for the same content may necessitate additional RTTs, adding latency to data transfers.

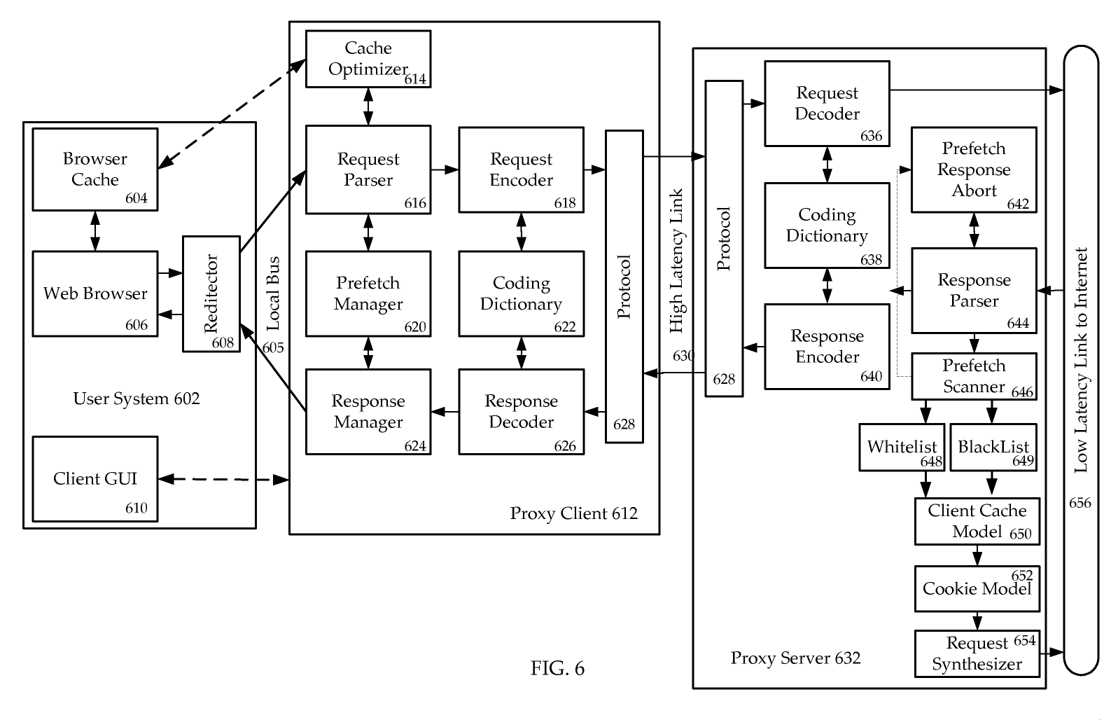

Turning now to FIG. 6 which illustrates a system for optimizing transfer of content from the Internet to a web browser. In one embodiment, the system may include a user system 602, a proxy client 612 and a proxy server 632. The user system may include a client graphical user interface (GUI) 610. Client GUI 610 may allow a user to configure performance aspects of system 600. For example, the user may adjust the compression parameters and/or algorithms, content filters (e.g., blocks elicit websites), and enable or disable various features used by system 600. In one embodiment, some of the features may include network diagnostics, error reporting, as well as controlling, for example, prefetch response abort 642. Such control may be adding and/or removing pages (i.e. URLs) to or from whitelist 648 and/or blacklist 649.

In one embodiment, the user selects a universal recourse locator (URL) address which directs web browser 606 (e.g., Internet Explorer®, Firefox®, Netscape Navigator®, etc.) to a website (e.g., cnn.com, google.com, yahoo.com, etc.). In a further embodiment, web browser 606 may check browser cache 604 to determine whether the website associated with the selected URL is located within browser cache 604. If the website is located within browser cache 604 the amount of time the website has been in the cache is checked to determine if the cached website is “fresh” (i.e. new) enough to use. For example, the amount of time that a website may be considered fresh may be 5 minutes; however, other time limits may be used. Consequently, if the website has been cached and the website is considered fresh, then web browser 606 renders the cached page. However, if the website has either not been cached or the cached webpage is not fresh, web browser 606 sends a request to the Internet for the website.

In one embodiment, redirector 608 intercepts the request sent from web browser 606. Redirector 608 instead sends the request through a local bus 605 to proxy client 612. In some embodiments, proxy client 612 may be implemented as a software application running on user system 602. In an alternative embodiment, proxy client 612 may be implemented on a separate computer system and is connected to user system 602 via a high speed/low latency link (e.g., a branch office LAN subnet, etc.). In one embodiment, proxy client 612 includes a request parser 616. Request parser 616 may check cache optimizer 614 to determine if a cached copy of the requested website may still be able to be used. Cache optimizer 614 is in communication with browser cache 604 in order to have access to cached websites. Cache optimizer 614 is able to access browser cache 604 without creating a redundant copy of the cached websites, thus requiring less storage space.

According to one embodiment, cache optimizer 614 implements more effective algorithms to determine whether a cached website is fresh. In one embodiment, cache optimizer 613 may implement the cache expiration algorithms from HTTP v1.1 (i.e., RFC 2616), which may not be natively supported in browser 606. For example, browser cache 604 may inappropriately consider a cached website as too old to use; however, cache optimizer 614 may still be able to use the cached website. More efficient use of cached websites can improve browsing efficiency by reducing the number of Internet accesses.

In one embodiment, if the requested website is not able to be accessed from the cached websites, request parser 616 checks prefetch manager 620 to determine if the requested website has been prefetched. Prefetching a response is when the item is requested from the website by the accelerator prior to receiving a request from the web browser 606. Prefetching can potentially save round-trips of data access from user system 602 to the Internet.

In a further embodiment, if the requested website has not been prefetched, then request parser 616 forwards the request to a request encoder 618. Request encoder 618 encodes the request into a compressed version of the request using one of many possible data compression algorithms. For example, these algorithms may employ a coding dictionary 622 to store strings so that data from previous web objects can be used to compress data from new pages. Accordingly, where the request for the website is 550 bytes in total, the encoded request may be as small as 50 bytes. This level of compression can save bandwidth on a connection, such as high latency link 630. In one embodiment, high latency link 630 may be a wireless link, a cellular link, a satellite link, a dial-up link, etc.

In one embodiment, after request encoder 618 generates an encoded version of the request, the encoded request is forwarded to a protocol 628. In one embodiment, protocol 628 is Intelligent Compression Technology's® (ICT) transport protocol (ITP). Nonetheless, other protocols may be used, such as the standard transmission control protocol (TCP). In one embodiment, ITP maintains a persistent connection with proxy server 632. The persistent connection between proxy client 612 and proxy server 632 enables system 600 to eliminate the inefficiencies and overhead costs associated with creating a new connection for each request.

In one embodiment, the encoded request is forwarded from protocol 628 to request decoder 636. Request decoder 636 uses decoder 636 which is appropriate for the encoding performed by request encoder 618. In one embodiment, this process utilizes a coding dictionary 638 in order to translate the encoded request back into a standard format which can be accessed by the destination website. Furthermore, if the HTTP request includes a cookie (or other special instructions), such as a “referred by” or type of encoding accepted, information about the cookie or instructions may be stored in a cookie cache 655. Request decoder 636 then transmits the decoded request to the destination website over a low latency link 656. Low latency link 656 may be, for example, a cable modem connection, a digital subscriber line (DSL) connection, a T1 connection, a fiber optic connection, etc.

In response to the request, a response parser 644 receives a response from the requested website. In one embodiment, this response may include an attachment, such as an image and/or text file. Some types of attachments, such as HTML, XML, CSS, or Java Scripts, may include references to other “in-line” objects that may be needed to render a requested web page. In one embodiment, when response parser 644 detects an attachment type that may contain such references to “in-line” objects, response parser 644 may forward the objects to a prefetch scanner 646.

In one embodiment, prefetch scanner 646 scans the attached file and identifies URLs of in-line objects that may be candidates for prefetching. For example, candidates may be identified by HTML syntax, such as the token “img src=”. In addition, objects that may be needed for the web page may also be specified in java scripts that appear within the HTML or CSS page or within a separate java script file. In one embodiment, the identified candidates are added to a candidate list.

In one embodiment, for the candidate URLs prefetch scanner 646 may notify prefetch abort 642 of the context in which the object was identified, such as the type of object in which it was found and/or the syntax in which the URL occurred. This information may be used by prefetch abort 642 to determine the probability that the URL will actually be requested by browser 606.

According to a further embodiment, the candidate list is forwarded to whitelist 648 and blacklist 649. Whitelist 648 and blacklist 649 may be used to track which URLs should be allowed to be prefetched. Based on the host (i.e. the server that is supplying the URL), the file type (e.g., application service provider (ASP) files) should not be prefetched, etc. Accordingly, whitelist 648 and blacklist 649 control prefetching behavior by indicating which URLs on the candidate list should or should not be prefetched. In many instances with certain webpages/file types prefetching may not work. In addition to ASP files, webpages which include fields or cookies may have problems with prefetching.

In one embodiment, once the candidate list has been passed through whitelist 648 and blacklist 649, a modified candidate list is generated, and then the list is forwarded to a client cache model 650. The client cache model 650 attempts to model which items from the list will be included in browser cache 604. As such, those items are removed from the modified candidate list. Subsequently, the updated modified candidate list is forwarded to a request synthesizer 654 which creates an HTTP request in order to prefetch each item in the updated modified candidate list. The HTTP request header may include cookies and/or other instructions appropriate to the web site and/or to browser 606's preferences using information obtained from cookie model 652. The prefetch HTTP requests may then be transmitted through low latency link 656 to the corresponding website.

In one embodiment, response parser 644 receives a prefetch response from the website and accesses a prefetch response abort 642. Prefetch response abort 642 is configured to determine whether the prefetched item is worth sending to user system 602. Prefetch response abort 642 bases its decision whether to abort a prefetch on a variety of factors, which are discussed below in more detail.

If the prefetch is not aborted, response parser 644 forwards the response to response encoder 640. Response encoder 640 accesses coding dictionary 638 in order to encode the prefetched response. Response encoder 640 then forwards the encoded response through protocol 628 over high latency link 630 and then to response decoder 626. Response decoder 626 decodes the response and forwards it to response manager 624. In one embodiment, if the response is a prefetched response then response manager 624 creates a prefetch socket to receive the prefetched item as it is downloaded.

Response manager 624 transmits the response over local bus 605 to redirector 608. Redirector 608 then forwards the response to web browser 606 which renders the content of the response.

In some embodiments (e.g., as shown in FIGS. 2 and 3), the terminal accelerator module 330 includes a terminal masker module 340 and/or the gateway accelerator module 250 includes a gateway masker module 246, adapted to implement URL masking functionality. Using URL masking functionality may allow the gateway prefetcher module 254 and/or the terminal prefetcher module 334 to operate in the context of some cache-busting techniques.

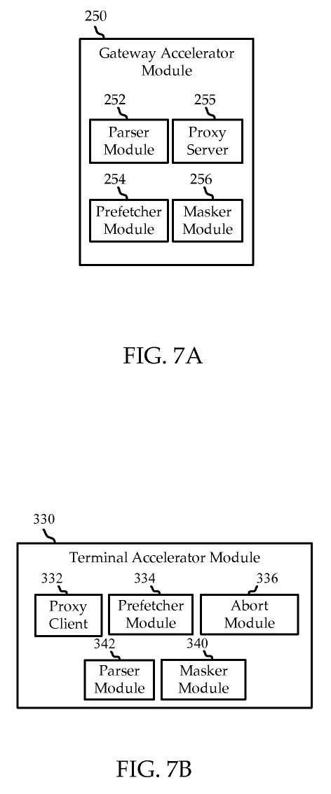

Turning now to FIG. 7A, which illustrates one embodiment of gateway accelerator module 250. In one embodiment, parser module 252 may identify an embedded URL string within a webpage, Java Script, etc. Further, parser module 252 may then analyze the URL string to determine if a cache-busting portion (or random portion) exists in the URL string. However, it should be noted that the random portion may not have anything to do with cache busting, and is placed in the URL string for utility value. For example, an advertisement server may embed or append a string of random characters in the URL string. Such a random string of characters may be used to cycle through ads to be presented to the browser. For example, random number 1 may produce an ad for company 1, random number 2 may produce an ad for company 2, and so forth.

The “random number” (or embedded string) may be generated in a variety of ways. For example, a rand( )method may be called to generate a binary number. Then an ASCI string may be generated from the binary number, which is then appended or embedded in the URL. Alternatively, a timestamp may be used to produce the “random” portion of the URL string. For example, the timestamp may be extended out several digits and converted into an ASCI string and appended or embedded within the URL sting.

Once the cache-busting portion of the URL string has been identified, the URL string may be passed to masker module 256. In one embodiment, the masker produces a mask that identifies which bytes in the URL string are effectively random. This may be implemented, for example, as a string of the same length as the URL where a byte is 0 if it is a normal byte and 1 if it is random. In this case, the mask can be used to exclude the random bytes in deciding whether two URLs match, such as in the C-language method:

```
bool isMatch(int urlLength, char* requestUrl, char* prefetchedUrl,
char* mask)
{
  for (int i=0; i<urlLength; ++i)
      if ((requestUrl[i] != prefetchedUrl[i]) && !mask[i])
            return false
  return true;
}
```

This mask can be sent to the client along with the URL string for the item that has been prefetched.

After masker module 256 has masked out the random portion of the URL string, the masked URL string is passed to prefetcher module 254. In one embodiment, prefetcher module 254 may compare the masked URL string with URL strings of objects that have already been prefetched by prefetcher module 254. If a match is found, then prefetcher module 254 may then notify prefetcher module 334 in terminal accelerator module 330 (FIG. 7B) that the object has already been prefetched, and not to prefetch it again, thus preventing sending unnecessary bytes across the link. Accordingly, the prefetched version of the object from the masked URL string is used to be rendered in the browser instead of prefetching a new object.

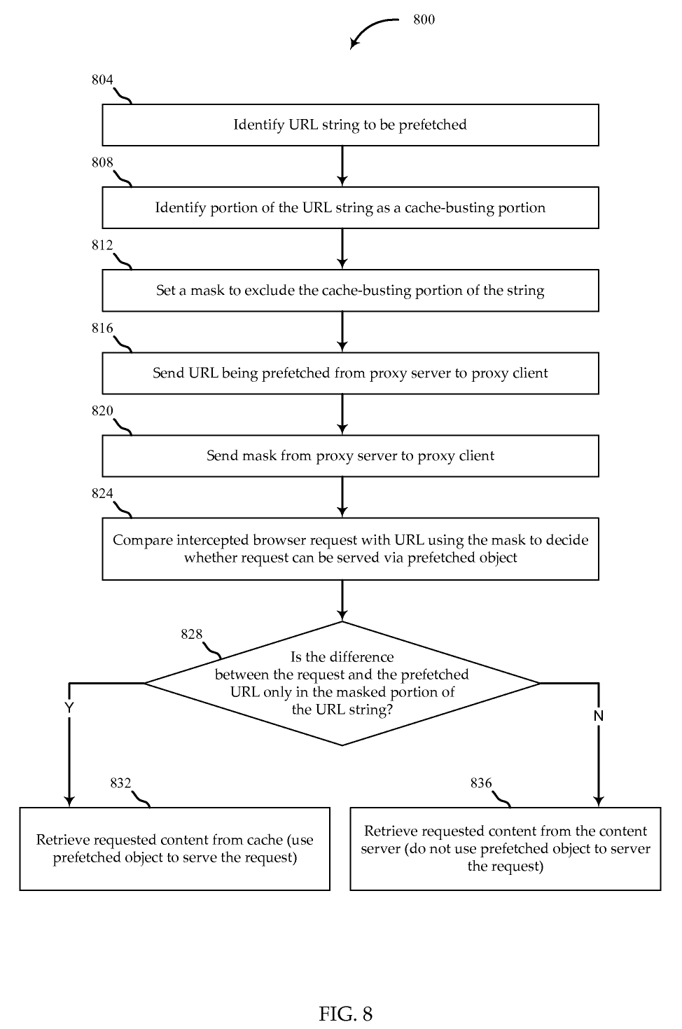

FIG. 8 shows an illustrative flow diagram of a method 800 for implementing URL masking functionality, according to various embodiments of the invention. The method 800 begins at block 804 by identifying a URL to be prefetched. At block 808, a portion of the URL string is identified as employing a cache-busting technique. A mask is then set, at block 812, to mask the cache-busting portion of the URL string. The URL string may be sent at block 816 from a proxy server to a proxy client. Further, at block 820, the mask may be sent from the proxy server to the proxy client. In certain embodiments, the proxy server is implemented in the gateway 115 (e.g., the proxy server 255 of FIG. 2) and the proxy client is implemented in the subscriber terminal 130 (e.g., the proxy client 332 of FIG. 3). The gateway 115 sends a list of URLs being prefetched to the subscriber terminal 130, where prefetched content may be cached (e.g., in the terminal cache module 335).

At block 824, the proxy client may compare intercepted browser requests with the list of URLs to decide whether a request can be served via a prefetched object. As part of this comparison in block 824, the proxy client applies the mask to the requested URL and/or the prefetched URL list. In this way, the proxy client is able to determine in block 828 whether the requested content is, in fact, from a non-prefetched URL; or if it is actually from the same URL employing a cache-busting technique.

If the only difference is in the masked portion of the request (e.g., the masked URL request matches the masked prefetched URL), the requested object(s) may be served in block 832 using prefetched (e.g., locally cached) content. Otherwise, the requested object(s) may be served in block 836 by retrieving the objects from other locations. For example, the requested object(s) may be retrieved from the gateway cache module 220, from a content server over the network 120, etc.

For example, a URL is identified by the gateway parser module 252 by means of parsing a Java script embedded in a web object with certain file extensions (e.g., HTML, XML, CSS, JS, or other protocols used within HTTP). Identifying the URL may involve constructing the string using various Java functions which may be defined in the web object or may be part of a library known to the parser. When constructing the string, embodiments of the gateway parser module 252 look for calls to library functions that may be used to make URLs unique each time they are constructed so as to prevent caches from fulfilling the request from copies of previously downloaded objects (e.g., known as “cache-busting”). Examples of cache-busting functions include random number generators or timers with millisecond resolution. If the parser determines that part of the URL is being constructed with characters derived from these cache-busting functions, embodiments of the gateway masker module 256 generate a mask as a function of the URL string to mask the millisecond timestamp portion of the URL string. The prefetcher issues a request to the web server for the URL that it constructs, and the URL string and mask information are sent from the gateway 115 (e.g., proxy server 255) to the subscriber terminal 130 (e.g., proxy client 332).

In some embodiments, the subscriber terminal 130 receives the URL and mask at the same time as it receives the object that it was embedded in, such as the HTML page. The terminal accelerator module 330 places the URL string and mask onto a “prefetch list” of objects that are in process of being prefetched. When the accelerator receives a subsequent HTTP GET request, the parser module 342 identifies the URL being requested and asks the prefetch list 336 whether this URL is being prefetched. The prefetch list 336 iterates through all entries to see if the request is a match. In order to determine if it is a match, calls are made to the masker module 340, supplying the request URL, the prefetched URL being tested, and the mask associated with the prefetched URL. The masker module 340 may perform a string comparison, excluding characters as a function of the mask. Embodiments return a Boolean value indicating whether the masked versions of the requested and prefetched URLs are a match. If so, the response to the CPE 160 may be filled using the prefetched object. Otherwise, the subscriber terminal 130 may request the objects from the gateway 115 (e.g., as proxy server 255) over the satellite communication system 100.

It will be appreciated that embodiments of the URL masking functionality may be applied both to prefetched content (e.g., to see if a prefetched object matches a client request) and to the use of cached content on the gateway cache module 220 and/or the terminal cache module 335. Further, it will be appreciated that URL masking functionality may allow prefetchers and caches to work even when the URLs are constructed using scripts intended to block such behavior. By facilitating the use of prefetching (e.g., by the gateway prefetcher module 254 and/or the terminal prefetcher module 334) and local caching (e.g., at the terminal cache module 335), the number of RTTs may be reduced. Local caching may also reduce some server response delays that affect communications over the satellite communication system 100.

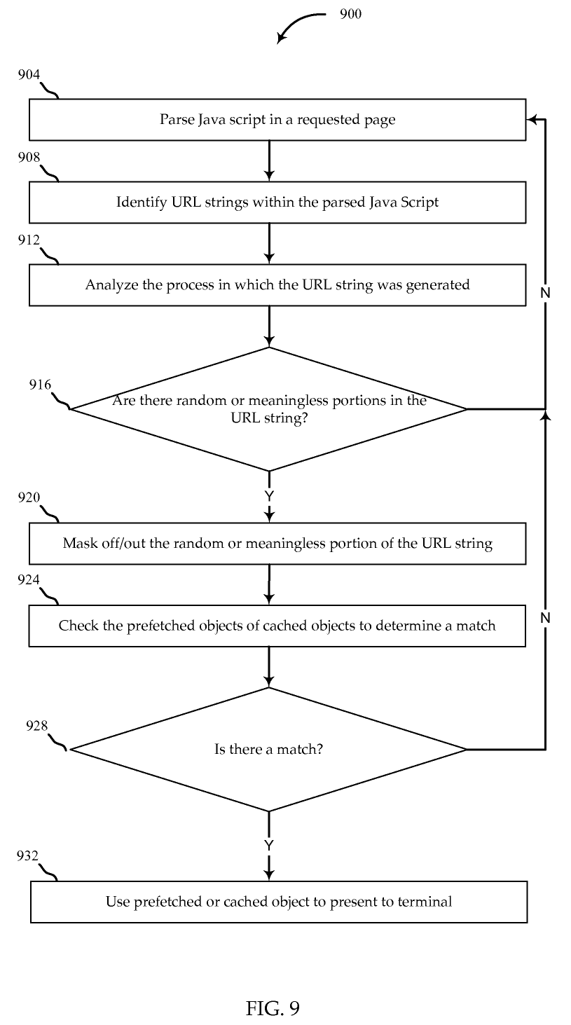

Referring next to FIG. 9, which illustrates a method 900 for implementing URL masking according to embodiments of the present invention. At process block 904, Java script included in a requested page may be parsed. During the parsing of the requested page URL string within the Java script may be identified and assembled (process block 908). Furthermore, the process of generating the identified URL string may be analyzed (process block 912).

In one embodiment, a determination may be made as to whether portions of the URL string were randomly generated so as to have a meaningless value (decision block 916). For example, the portion of the URL string may be a randomly generated number, a timestamp, etc. If no random portion of the URL is found, then the Java script is continued to be parsed. Otherwise, at process block 920, the random or meaningless portion of the URL string is masked out/off of the URL string.

Then, at process block 924, the masked version of the URL may be checked against prefetched URL strings and/or cached URL strings to determine a match. At decision block 928, it is determined if there is a match, and at process block 932, the matching prefetched or cached object associated with the determined URL string is presented to the terminal. Accordingly, a cached or prefetched object is able to be used where it otherwise would have been classified as a cache miss or a non-prefetched object.

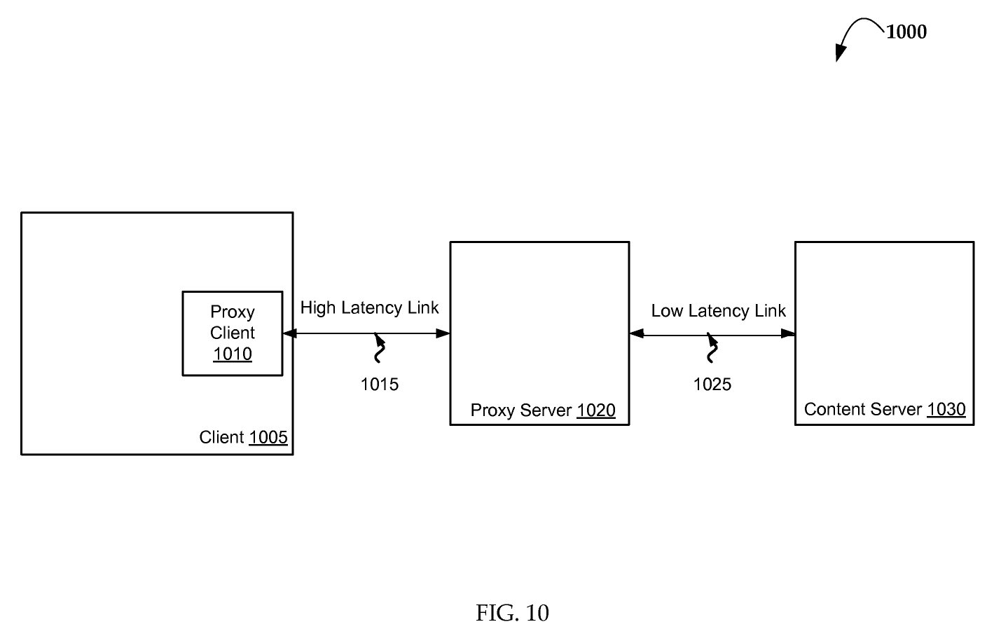

FIG. 10 illustrates one embodiment of a system 1000 according to aspects of the present invention. In one embodiment, system 1000 may include a client 1005. Client 1005 may be configured to use a web browser to access various Internet and/or intranet web pages, or to access files, emails, etc. from various types of content servers. In one embodiment, client 1005 may include a proxy client 1010 which may intercept the traffic from the browser. Client 1005 may be configured to communicate over a high latency link 1015 with proxy server 1020 using an optimized transport protocol.

In one embodiment, proxy server 1020 may identify, based on a request received from proxy client 1010 via client 1005's browser, objects that may be able to be prefetched. Furthermore, proxy server 1020 may store all of the caching instructions for all objects downloaded by proxy server 1020 on behalf of client 1005.

In one embodiment, proxy server 1020 may send a request over a low latency link 1025 to a content server 1030. In one embodiment, low latency link 1025 may be a satellite link, a broadband link, a cable link, etc. In a further embodiment, the request may request the caching instructions for the object that may potentially be prefetched from the web server. Proxy server 1020 may then analyze the caching instructions for the object to determine if the object has been modified since it was last prefetched. Accordingly, if the object has been modified, then proxy server 1020 would download the updated version of the object from content server 1030. Otherwise, if the previously prefetched object is still valid, no prefetching is needed. Thus, proxy server 1020 can simply use the previously prefetched object.

A number of variations and modifications of the disclosed embodiments can also be used. For example, content server 1030 may be a file server, an FTP server, etc. and various web browsers may be used by client 1005. Furthermore, the cache model may be modified to be stored, for example, at proxy client 1010. As such, proxy client 1010 may be configured to maintain the caching instructions associated with each prefetched object. In a further embodiment, proxy client 1010 may store cached (or prefetched) objects for future access by client 1005, or in an alternative embodiment, to be accessed by other clients and/or servers connected with client 1005. Consequently, any component in FIG. 10 may be configured to store prefetched (or cached) objects and/or caching instructions.

In an additional embodiment, the cache model may be implemented at a separate location from client 1005 and/or client proxy 1010. For example, the cache model may be located at a remote server, database, storage device, remote network, etc. In one embodiment, cached objects may be stored remotely from client 1005 and retrieved from the remote location upon request of the object.

While the principles of the disclosure have been described above in connection with specific apparatuses and methods, it is to be clearly understood that this description is made only by way of example and not as limitation on the scope of the disclosure. Further, embodiments described with reference to functionality of the subscriber terminal 130 may be implemented by or at the gateway, and vise versa.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with- or without-certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of implementing URL masking, the method comprising:
receiving, at a terminal, a web content request including a URL string for locating the web content;
comparing, at a parser module on the terminal, the URL string to a list of URLs for which prefetched responses are available to determine if the request can be fulfilled from the prefetched responses;
using a mask that excludes portions of the URL string that are not relevant to finding or selecting web content when comparing the request to the list of prefetched URLs;
if the masked URL string matches the URL of one of the prefetched responses, supplying the prefetched response to be used as a response to the incoming request;
parsing scripts in a web response to search for URLs that are rendered on a web page;
analyzing the scripts to identify bytes in the URL that generate random values; and
generating a mask which indicates bytes that are random and that are to be excluded from a comparison in order to determine whether the prefetched response can be used to response to the web content request.

2. A method of implementing URL masking according to claim 1, wherein the random values in the URL string comprise a cache busting string.

3. A method of implementing URL masking according to claim 1, wherein the web content request is a Java script.

4. A method of implementing URL masking according to claim 3, further comprising parsing, at the parser module, the Java script to identify an embedded URL.

5. A method of implementing URL masking according to claim 4, further comprising in response to identifying an embedded URL, determining the process in which the embedded URL was constructed.

6. A method of implementing URL masking according to claim 5, wherein the process comprises:
executing a random number generator to produce a binary string;
converting the binary string into an ASCI string; and
inserting the ASCI string into the embedded URL.

7. A method of implementing URL masking according to claim 6, wherein the embedded URL is the URL string and the ASCI string is the unrelated portion of the URL string.

8. A method of implementing URL masking according to claim 1, wherein the unrelated portion of the URL string is generated using a timestamp value.

9. A method of implementing URL masking according to claim 8, further comprising removing at least a portion of the timestamp value from the URL string to mask the URL string.

10. A method of implementing URL masking according to claim 1, further comprising comparing the masked URL with cached URLs in the terminal's cache.

11. A method of implementing URL masking according to claim 10, further comprising in response to determining that the masked URL matches one of the cached URLs, rendering the web content associated with the cached URL at the terminal.

12. A method of implementing URL masking according to claim 11, wherein the cache is a squid web proxy cache.

13. A method of implementing URL masking according to claim 11, wherein the cache is a browser cache.

14. A method of implementing URL masking according to claim 1, the terminal is a satellite terminal.

15. A system for implementing URL masking, the system comprising:
a gateway configured to receive a web content request including a URL string for locating the web content; and
a terminal in communication with the gateway, the terminal configured to receive the web content request form the gateway, compare the URL string to a list of URLs for which prefetched responses are available to determine if the request can be fulfilled from the prefetched responses, use a mask that excludes portions of the URL string that are not relevant to finding or selecting web content when comparing the request to the list of prefetched URLs, if the masked URL string matches the URL of one of the prefetched responses, supply the prefetched response to be used as a response to the incoming request, parse scripts in a web response to search for URLs that are rendered on a web page, analyze the scripts to identify bytes in the URL that generate random values, generate a mask which indicates bytes that are random and that are to be excluded from a comparison in order to determine whether the prefetched response can be used to response to the web content request.

16. The system for implementing URL masking according to claim 15, wherein the gateway is a satellite gateway and the terminal is a subscriber terminal.

17. The system for implementing URL masking according to claim 16, wherein the satellite gateway and the subscriber terminal are in communication via a satellite link.

18. A gateway configured to implementing URL masking, the gateway comprising:
an accelerator module configured to receive a web content request including a URL string for locating the web content, wherein the accelerator module includes:
a parser module configured to analyze the URL string to determine if the URL string includes a portion within the string that is unrelated to locating the web content;
a masker module coupled with the parser module, the masker module configured to, in response to determining that the URL string includes a portion that is unrelated to determining the location of the web content, create a mask that indicates which bytes are to be excluded from the URL string when determining whether a request matches a prefetched or cached response; and
a prefetcher module coupled with the masker module, the prefetcher module configured to compare the masked URL string with prefetched URL strings stored by the prefetcher module, and in response to the masked URL matching one of the prefetched URL string, retrieve a prefetched object associated with the one of the prefetched URL strings; and
a gateway transceiver module in communication with the accelerator module, the gateway transceiver module configured to receive the prefetched object and transmit the prefetched object to a terminal.

19. A gateway configured to implementing URL masking according to claim 18, wherein the unrelated portion of the URL string is a cache busting string.

20. A machine-readable medium for implementing URL masking, which includes sets of instructions which, when executed by a machine, cause the machine to:
receive, at a terminal, a web content request including a URL string for locating the web content;
compare, at a parser module on the terminal, the URL string to a list of URLs for which prefetched responses are available to determine if the request can be fulfilled from the prefetched responses;
use a mask that excludes portions of the URL string that are not relevant to finding or selecting web content when comparing the request to the list of prefetched URLs;
if the masked URL string matches the URL of one of the prefetched responses, supply the prefetched response to be used as a response to the incoming request;
parse scripts in a web response to search for URLs that are rendered on a web page;
analyze the scripts to identify bytes in the URL that generate random values; and
generate a mask which indicates bytes that are random and that are to be excluded from a comparison in order to determine whether the prefetched response can be used to response to the web content request.
